(19) United States
(12) Patent Application Publication
(10) Pub. No.: US 2014/0160513 A1
(43) Pub. Date: Jun. 12, 2014

(54) IMAGE FORMING APPARATUS, CONTROL METHOD FOR IMAGE FORMING APPARATUS, AND PROGRAM

(71) Applicant: CANON KABUSHIKI KAISHA, Tokyo (JP)

(72) Inventor: Hiroaki Niitsuma, Yokohama-shi (JP)

(73) Assignee: CANON KABUSHIKI KAISHA, Tokyo (JP)

(21) Appl. No.: 14/091,596

(22) Filed: Nov. 27, 2013

(30) Foreign Application Priority Data
Dec. 7, 2012 (JP) 2012-267893

(51) Int. Cl. H04N 1/00; G06K 15/00

(52) U.S. Cl. CPC H04N 1/00888; G06K 15/4055
USPC 358/1.14

(57) ABSTRACT

The present invention aims to, even if a job for which there is a strong possibility that necessary power exceeds maximum power consumption is requested, process the job in an operation mode in which necessary power does not exceed the maximum poser consumption. Thus, in case of performing a copy function of printing an image on a paper based on read and acquired image data, an image forming apparatus performs control not to simultaneously perform a reading operation of reading an image of an original and a printing operation of printing an image on a paper, when information for restricting an amount of power that the image forming apparatus can use has been received, and performs control to simultaneously perform the reading operation of reading the image of the original and the printing operation of printing the image on the paper, when the information is not received.

### BACKGROUND OF THE INVENTION

1. Field of the Invention

The present invention relates to an image forming apparatus which thermally fixes an image transferred onto a sheet or a paper, a control method for the image forming apparatus, and a program for achieving the control method.

2. Description of the Related Art

In recent years, with an increase in consciousness of environments and energies, equipment with small power consumption is required in markets. In addition, it is necessary to pay attention to the maximum power consumption of equipment in order to deal with an unforeseen situation that power supply becomes tight, or in order to operate within a permissible amount of power supply in an establishment of a certain range to which power is supplied. In any case, it should be noted that equipment such as a printer, a multifunction machine or the like installed in an office is generally classified into one of groups of electronic devices of which the power usage is larger. In particular, in a printer or a multifunction machine in which an electrophotographic system has been adopted, power consumption at the time of printing is maximum because it is necessary to thermally fix a toner image on a paper.

That is, there is a fear that the maximum power consumption at the time of operation of the printer or the multifunction machine of the electrophotographic system exceeds the permissible amount of power supply in the above case of the unforeseen situation that the power supply becomes tight, or in the case where the permissible amount of power supply has determined in the establishment of the certain range to which the power is supplied. Therefore, power saving is necessary in regard to the maximum power consumption in the operation of the printer or the multifunction machine. Conventionally, there has been a power saving control technique for achieving an operation mode in which power consumption is reduced by partially restricting the functions of the printer or the multifunction machine.

For example, Japanese Patent Application No. 2011-204220 discloses a technique which achieves power saving control capable of changing control contents of an operation mode according to user's selection. In particular, this technique is characterized by presenting to a user the operation mode in which the control contents of the equipment are restricted for achieving a certain amount of power consumption as a target, and thus causing the user to select the presented operation mode. Here, in the operation mode in which the control contents of the equipment are restricted, for example, page-intensive printing of integrating original images of a plurality of pages into one page and then printing these images, validation of transition setting to a power saving mode, shortening of transition time to the power saving mode, and the like are disclosed.

### SUMMARY OF THE INVENTION

Although the technique disclosed in Japanese Patent Application No. 2011-204220 is effective as power saving technique of reducing the amount of power consumption based on the certain amount of power consumption, Japanese Patent Application No. 2011-204220 does not consider any short-time reduction of the maximum power consumption of the equipment. Besides, it might be unfavorable for a user that the operation mode in which the control contents of the equipment are restricted affects an appearance of a printed material to be output. For example, when the page-intensive printing of integrating the original images of the plurality of pages into one page is presented from the equipment, a situation of compelling the user to unwillingly accept and select the page-intensive printing is conceivable. The present invention has been completed in consideration of such problems as described above, and thus aims to control the operation mode of the equipment so as to reduce the short-time maximum power consumption of the equipment.

The present invention has been completed to solve the above problems, and an object thereof is to provide a mechanism which can perform, even if a job of which the necessary power consumption exceeds the maximum power consumption is requested, a process of the job by using an operation mode for which the necessary power consumption does not exceed the maximum power consumption.

To achieve the above object, an image forming apparatus according to the present invention comprises the following constitution.

That is, the image forming apparatus is characterized by comprising: a reading unit configured to read an image of an original in a reading operation; a printing unit configured to print an image on a paper in a printing operation; a receiving unit configured to receive information for restricting an amount of power that the image forming apparatus can use; and a control unit configured to, in case of performing a copy function by which the printing unit prints an image on a paper based on image data acquired by the reading unit, perform control not to simultaneously perform the reading operation in which the reading unit reads the image of the original and the printing operation in which the printing unit prints the image on the paper, when the receiving unit has received the information, and perform control to simultaneously perform the reading operation in which the reading unit reads the image of the original and the printing operation in which the printing unit prints the image on the paper, when the receiving unit does not receive the information.

Further features of the present invention will become apparent from the following description of exemplary embodiments with reference to the attached drawings.

### BRIEF DESCRIPTION OF THE DRAWINGS

FIG. 1 is a block diagram illustrating a configuration of an image processing system in which an image forming apparatus according to the present invention is used.

FIG. 2 is a block diagram for describing a constitution of the main controller illustrated in FIG. 1.

FIG. 3 is a cross-section diagram illustrating an internal constitution of the image forming apparatus illustrated in FIG. 1.

FIGS. 4A, 4B and 4C are characteristic diagrams for describing states of power consumption according to a job process of the image forming apparatus.

FIGS. 5A and 5B are diagrams illustrating relation between temperatures of a fixing unit and inter-paper intervals in paper transportation.

FIG. 6 is a diagram illustrating an operation mode table on which print speed and maximum power consumption are associated with each other.

FIG. 7 is a flow chart for describing a control method of the image forming apparatus.

FIGS. 8A, 8B and 8C are characteristic diagrams for describing states of power consumption according to a job process of the image forming apparatus.

FIG. 9 is a flow chart for describing a control method of the image forming apparatus.

FIG. 10 is a diagram illustrating an operation mode table on which print speed, a scanning process and maximum power consumption are associated with others.

FIG. 11 is a flow chart for describing a control method of the image forming apparatus.

### DESCRIPTION OF THE EMBODIMENTS

Hereinafter, exemplary embodiments of the present invention will be described.

### DESCRIPTION OF SYSTEM CONFIGURATION

### First Embodiment

### Image Forming Apparatus

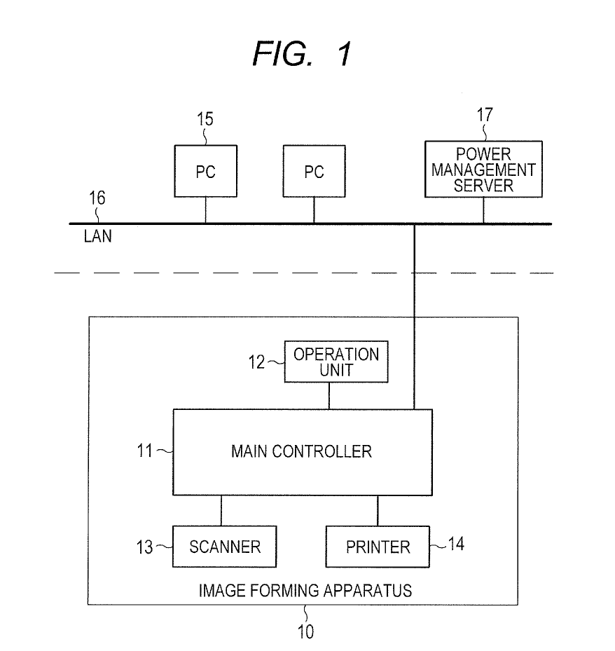

FIG. 1 is a block diagram illustrating a configuration of an image processing system in which an image forming apparatus according to the present embodiment is used. Incidentally, a multifunction machine, which inputs, outputs, transmits and receives image data concerning images, and performs various image processes, is used as an example of the image forming apparatus. In the present embodiment, a scanner 13 and a printer 14 are provided as a plurality of job execution units which perform job processes of which function processes are different respectively.

In FIG. 1, an image forming apparatus 10 is equipped with a main controller 11, an operation unit 12 which serves as a user interface, the scanner 13 which serves as an image input device, and the printer 14 which serves as an image output device. Incidentally, the operation unit 12, the scanner 13 and the printer 14, which are respectively connected to the main controller 11, are controlled in response to respective instructions issued from the main controller 11.

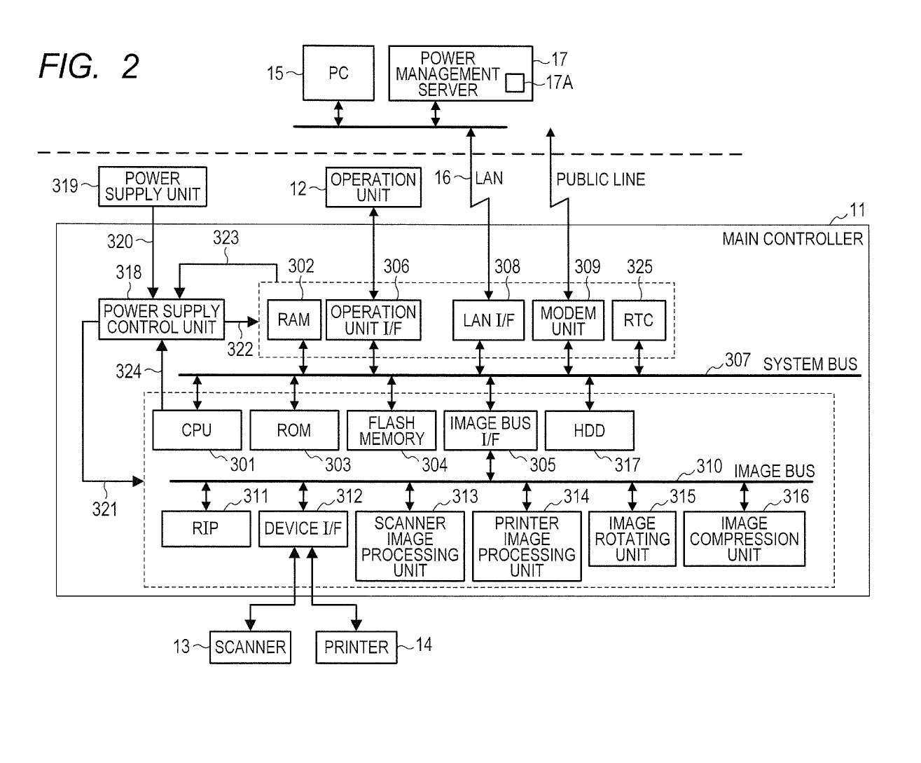

Moreover, the main controller 11 is connected to a LAN (local area network) 16, and is further connected to a power management server 17 and PCs (personal computers) 15 through the LAN 16. A CPU (central processing unit) 17A (FIG. 2) of the power management server 17 continuously monitors states of power supplied from a commercial power supply in a circumstance that the image forming apparatus 10 and not-illustrated other electronic devices have been installed, and notifies information concerning power consumption in response to an inquiry from the device connected through the LAN 16. The PC 15, which is a general-purpose personal computer, performs communication with the image forming apparatus 10 and the not-illustrated other electronic devices connected through the LAN 16.

Subsequently, the constitution of the main controller 11 included in the image forming apparatus 10 will be described in detail with reference to FIG. 2. The main controller 11, which controls the apparatus as a whole, further controls the scanner 13 and the printer 14, and is on another front connected to the LAN 16 and a public line. Then, the main controller 11 controls to input and output image information, device information, files and the like from and to external devices through the LAN 16 and the public line. Incidentally, the main controller 11 is equipped with a CPU 301 which serves as a main control unit.

The CPU 301 is connected to a RAM (random access memory) 302, a ROM (read only memory) 303, a flash memory 304, an image bus I/F (interface) 305, an operation unit I/F 306, a LAN I/F 308, a modem unit 309 and an RTC (real time clock) 325, through a system bus 307. The RAM 302 is a memory in which data can be read and written at all times, thereby providing a working area for the CPU 301. The RAM 302 is also used as an image memory in which image data can be temporarily stored.

The ROM 303 is a boot ROM in which a system boot program has been stored. The flash memory 304 is a non-volatile memory in which system software, configuration value data and the like which have to be maintained even after power shutoff of the image forming apparatus 10 are stored. The operation unit I/F 306 is an interface which is used to input and output data and information between the main controller 11 and the operation unit 12.

The operation unit I/F 306 is used to output the image data to be displayed to the operation unit 12, and to transfer the information input by a user through the operation unit 12 to the CPU 301. The LAN I/F 308 is an interface which is used to connect the main controller 11 to the LAN 16, and is used to input and output information from and to the LAN 16.

The modem unit 309 is an interface which is used to connect the main controller 11 to the public line. More specifically, the modem unit 309 inputs and outputs information from and to the public line. The image bus I/F 305 is an interface which is used to connect the system bus 307 to an image bus 310 by which image data can be transferred at high speed. Namely, the image bus I/F 305 serves as a bus bridge for transforming a data structure.

Incidentally, an RIP (raster image processor) 311, a device I/F 312, a scanner image processing unit 313, a printer image processing unit 314, an image rotating unit 315 and an image compression unit 316 are connected to the image bus 310. More specifically, the RIP 311 decompresses PDL (page description language) data received from the LAN 16 into a bitmap image (bitmap data). The device I/F 312 is an interface which is used to connect the scanner 13 and the printer 14 to the main controller 11. Moreover, the device I/F 312 performs synchronous/asynchronous transformation of image data.

The scanner image processing unit 313 performs processes such as correction, treating, editing and the like to the input image data read from the scanner 13. The printer image processing unit 314 performs processes such as color conversion, filtering, resolution conversion and the like to the print output data to be output to the printer 14. The image rotating unit 315 performs rotation to the image data. The image compression unit 316 performs a JPEG (Joint Photographic Experts Group) compression/decompression process to multivalued image data, and performs compression/decompression processes such as a JBIG (Joint Bi-level Image experts Group) process, an MMR (Modified Modified Read) process, an MH (Modified Huffman) process and the like to binary image data.

An HDD (hard disk drive) 317 is a non-volatile data storage device, in which various data such as image data, address book data, job logs, user individual data and the like are stored and held.

Incidentally, in such a constitution as the main controller 11 does not include the HDD 317, it is assumed that above various data are stored in the flash memory 304. Moreover, a power supply control unit 318 supplies DC (direct-current) power, which is received from a power supply unit 319 serving as a power supply unit through a power supply line 320, to predetermined circuit elements of the main controller 11 through power supply lines 321 and 322 respectively. The power supply control unit 318 performs power supply control of the power supply lines 321 and 322 based on a control signal received from the LAN I/F 308 through a control signal line 323 and a control signal received from the CPU 301 through a control signal line 324.

The power supply line 321 is connected to the CPU 301, the ROM 303, the flash memory 304, the image bus I/F 305 and the HDD 317. Moreover, the power supply line 321 is connected to the RIP 311, the device I/F 312, the scanner image processing unit 313, the printer image processing unit 314, the image rotating unit 315 and the image compression unit 316. The power supply line 322 is connected to the RAM 302, the operation unit I/F 306, the LAN I/F 308, the modem unit 309 and the RTC 325.

<Image Forming Apparatus/Internal Constitution>

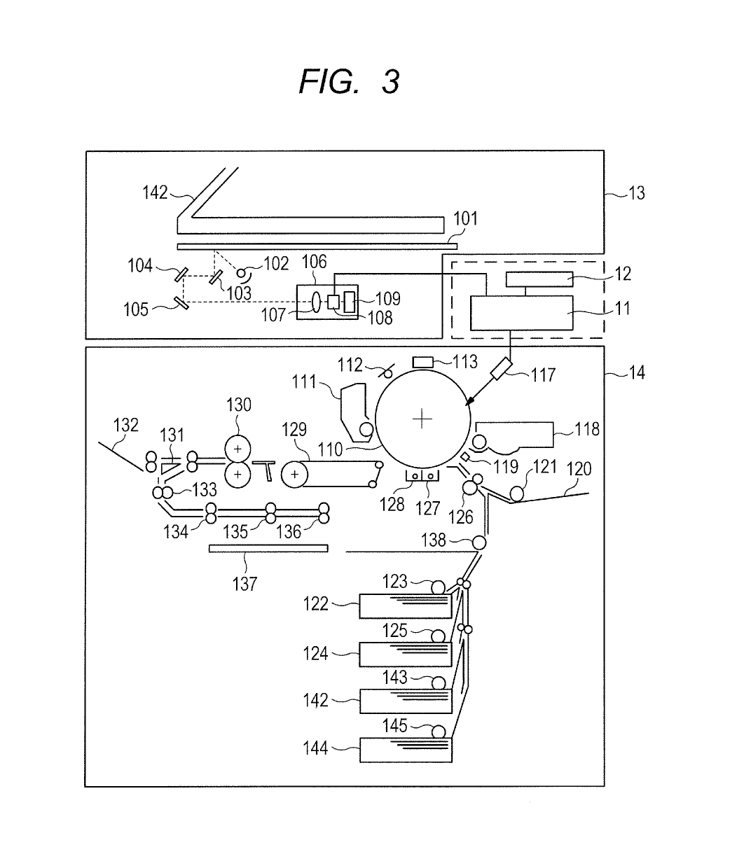

FIG. 3 is a cross-section diagram illustrating the internal constitution of the image forming apparatus illustrated in FIG. 1.

In FIG. 3, in response to instructions received from the user through the PC 15 and the operation unit 12, the main controller 11 controls the scanner 13 to read original images and controls the printer 14 to perform printing on papers. Subsequently, a scanning process to be performed by the scanner 13 and a printing process to be performed by the printer 14 will be minutely described in sequence with reference to the drawing.

First, in the scanning process, an automatic document feeder 142 sequentially transports original documents (hereinafter, called originals) set by the user onto a platen glass 101. An original illumination lamp 102 is a lamp which is constituted by, e.g., a halogen lamp and used to illuminate the original set on the platen glass 101. Scanning mirrors 103, 104 and 105, which have been held within a not-illustrated optical scanning unit, introduce reflected light from the original into a CCD (charge-coupled device) unit 106.

The CCD unit 106 is constituted by, for example, a CCD imaging element 108, an imaging lens 107 for providing an image based on the reflected light form the original, a CCD driver 109 for driving the CCD imaging element 108, and the like. An image signal of the original output from the CCD imaging element 108 is converted into, e.g., eight-bit digital data, and the acquired digital data is then input into the main controller 11, thereby performing original reading.

Next, in the printing process, a photosensitive drum 110 is neutralized by a pre-exposure lamp 112 in preparation for forming. Then, a primary charging unit 113 uniformly charges the photosensitive drum 110. An exposure unit 117, which is constituted by, e.g., a semiconductor laser or the like, exposes the photosensitive drum 110 based on the image data processed by the main controller 11, thereby forming an electrostatic latent image. Toners which serve as developer have been held in a developing unit 118. A before-transfer charging unit 119 applies high voltage before a toner image developed on the photosensitive drum 110 is transferred to the paper.

Paper feeding units 120, 122, 124, 142 and 144, which feed papers respectively, transport the papers into the apparatus by means of driving of respective paper feeding rollers 121, 123, 125, 143 and 145. Here, the paper feeding unit 120 is the manual paper feeding unit. The paper transported from each of the paper feeding units 120, 122, 124, 142 and 144 is once stopped at the position where a registration roller 126 has been disposed, and then the stopped paper is again transported in synchronization with writing of the image formed on the photosensitive drum 110. A transfer charging unit 127 transfers the toner image developed on the photosensitive drum 110 onto the transported paper.

A separation charging unit 128 is used to separate the paper, on which the transfer operation has been completed, from the photosensitive drum 110. Here, the residual toners not transferred are eliminated or recycled by a cleaner 111. A transportation belt 129 is used to transport the paper, on which the transfer process has been completed, to a fixing unit 130. Then, the fixing unit 130, which is heated by a not-illustrated heater, thermally fixes the toners to the paper.

A flapper 131 is used to control the transportation path of the paper to which the fixing process has been completed, so that the paper is transported to either a paper discharge tray 132 or an intermediate tray 137. Incidentally, transportation rollers 133, 134, 135 and 136 are used to transport the paper, to which the fixing process has been completed once, to the intermediate tray 137 in an inversion state (multiple printing) or a non-inversion state (both-sided printing). Then, a re-transportation roller 138 is used to again transported the paper, which has been put on the intermediate tray 137, to the position where the registration roller 126 has been disposed. The paper on which the image has been formed through the above image forming operation is then discharged onto the paper discharge tray 132, whereby the printing on the paper is completed.

<Image Forming Apparatus/Power Operation Mode>

The image forming apparatus 10 has two power modes which are roughly classified into a normal power mode and a power saving mode of which the respective power states are different according to operation conditions of the apparatus. Incidentally, in both the normal power mode and the power saving mode, the power supply unit 319 supplies power to the power supply control unit 318 through the power supply line 320. Moreover, in the normal power mode, the CPU 301 controls the power supply control unit 318 to make the power supply to the power supply lines 321 and 322 effective.

Thus, in the normal power mode, the power is supplied from the power supply unit 319 to both the CPU 301 and the LAN I/F 308. On the other hand, in the power saving mode, the CPU 301 controls the power supply control unit 318 to make the power supply to the power supply line 322 effective, so that the power supply to the power supply line 321 becomes ineffective.

At this time, the power to be supplied to the main circuit elements including the CPU 301 all disposed in the main controller 11 is shut off. As a result, in the power saving mode, the power consumption of the image forming apparatus 10 can be significantly reduced as compared with the normal power mode. When the LAN I/F 308 receives the data such as a print job or the like from the PC 15 on the LAN 16, the LAN I/F 308 controls the power supply control unit 318 to return the mode from the power saving mode to the normal power mode.

In the power saving mode, the RAM 302 comes into a low power consumption state while backing up the system program by a self-refresh operation, such that the power supply unit 319 supplies the power to the RAM 302.

Incidentally, it should be noted that data can be input and output between the LAN I/F 308 and the RAM 302 by a DMA (direct memory access) transfer operation using a not-illustrated DMA control unit provided by the LAN I/F 308. Besides, although the power supply to the CPU 301 is shut off in the power saving mode, the present invention is not limited to this. For example, as another embodiment, it is possible to set as the power saving mode a state in which the operation frequency of the CPU 301 is reduced by reducing the power supply to the CPU 301 as compared with that in the normal power mode.

<Image Forming Apparatus/Operation Control in Normal Power Mode>

Further, in the normal power mode of the image forming apparatus 10, operation control for reducing the maximum power consumption is performed according to the power which is usable at the time when the image forming apparatus 10 starts the print job.

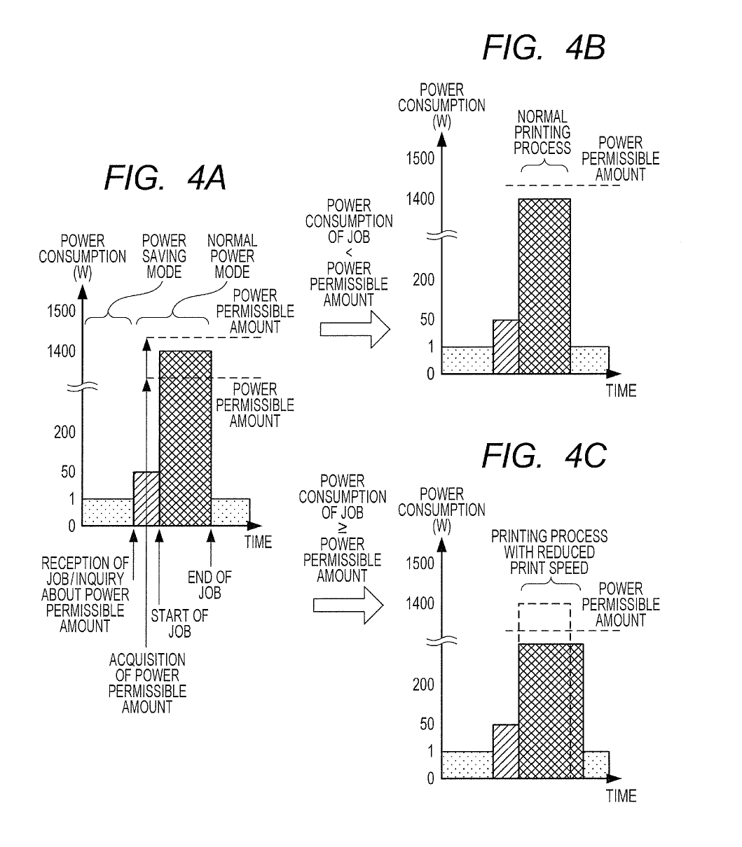

FIGS. 4A to 4C are characteristic diagrams for describing the states of the power consumption according to the job process of the image forming apparatus in the present embodiment. Hereinafter, transition of the operation mode of the image forming apparatus 10 from the power saving mode to the normal power mode and the print job that the image forming apparatus 10 performs in the normal power mode will be described with reference to FIGS. 4A to 4C. Here, it should be noted that, in the drawings, the vertical axis indicates the power consumption (W) of the image forming apparatus 10 and the horizontal axis indicates time.

As illustrated in FIG. 4A, when the image forming apparatus 10 receives the print job from the PC 15 on the LAN 16 in the power saving mode, the operation mode transitions from the power saving mode to the normal power mode.

Then, the image forming apparatus 10 inquires of the power management server 17 as to a power permissible amount of the power which is currently usable by the image forming apparatus 10. Here, since the CPU 17A of the power management server 17 continuously monitors the states of the power supplied from the commercial power supply in the circumstance that the image forming apparatus 10 and not-illustrated other electronic devices have been installed, the CPU 17A notifies, as the power permissible amount, the power usable by the image forming apparatus 10, in regard to the inquiry from the image forming apparatus 10.

Here, it should be noted that the power permissible amount is the amount of the power which is allocated from the total supply power as the power usable by the image forming apparatus 10 in, for example, a case where the power supplied from a power plant becomes tight and thus use of the commercial power supply is restricted, a case where use of the power is restricted for preventing a breaker of a distribution board from operating, or the like.

When the information indicating the power permissible amount is received from the power management server 17, the image forming apparatus 10 compares the received power permissible amount with the power to be used in the printing process of the print job started hereafter. Then, if the received power permissible amount is larger than the power consumption necessary for the printing process of the print job started hereafter by the image forming apparatus 10, the normal printing process can be performed within the range of the power usable by the image forming apparatus 10. Thus, the image forming apparatus 10 performs the print job as illustrated in FIG. 4B.

On the other hand, if the received power permissible amount is equal to or smaller than the power consumption necessary for the printing process of the print job started hereafter by the image forming apparatus 10, the normal printing process cannot be performed within the range of the power usable by the image forming apparatus 10.

Consequently, operation control is performed to reduce the maximum power consumption of the image forming apparatus 10. The detail of the operation control will be described hereinafter. The power consumption of the image forming apparatus 10 becomes maximum when the temperature of the fixing unit 130 is increased by the heating of the heater to a temperature equal to or higher than a toner melting point for fixing toner to a paper. Here, a gradient of temperature increase of the fixing unit 130 by the heating of the heater correlates with the power necessary for the heating of the heater. More specifically, the more the heater is heated faster, the more the power consumption of the image forming apparatus 10 becomes large. Consequently, it is possible to reduce the maximum power consumption of the image forming apparatus 10 by reducing the power to be used for the heater which heats the fixing unit 130.

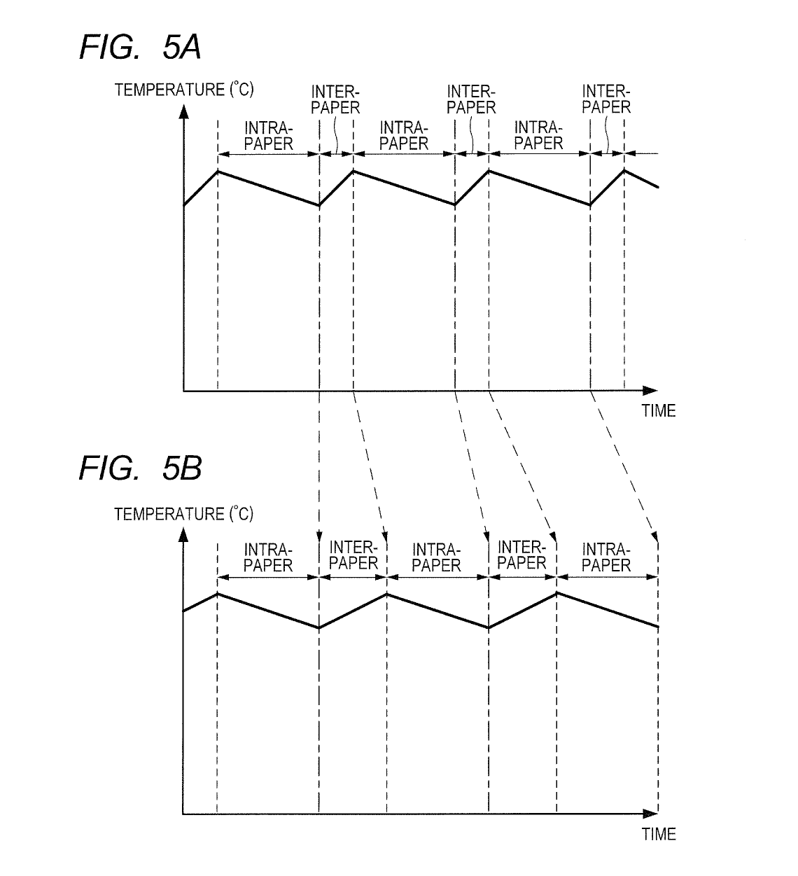

FIGS. 5A and 5B are diagrams illustrating relation between the temperatures of the fixing unit 130 and inter-paper intervals in the paper transportation at the time when the image forming apparatus 10 performs the printing process.

In each of FIGS. 5A and 5B, the vertical axis indicates the temperature (° C.) of the fixing unit 130 and the horizontal axis indicates time. FIG. 5A indicates temperature changes of the fixing unit 130 at the time when the image forming apparatus 10 performs the printing process within the range of the usable power, as in the case of FIG. 4A.

On the other hand, FIG. 5B indicates temperature changes of the fixing unit 130 at the time when the power used for the heater to heat the fixing unit 130 is reduced in the case where the image forming apparatus 10 cannot perform the printing process within the range of the usable power, as in the case of FIG. 4C.

In each of FIGS. 5A and 5B, “intra-paper” is the point of time that the fixing unit 130 thermally fixes the toner to the paper transported in the image forming apparatus 10. In this point of time, the temperature of the fixing unit 130 decreases because heat is absorbed by the paper.

Moreover, in each of FIGS. 5A and 5B, “inter-paper” is the point of time between the successive papers both transported in the image forming apparatus 10. In this point of time, the fixing unit 130 is gradually heated by the heater. Here, it should be noted that the interval of the “inter-paper” can be changed by driving control of the paper feeding rollers 121, 123, 125, 143 and 145 of the image forming apparatus 10.

The gradient of temperature increase by the heating of the heater of the fixing unit 130 in the “inter-paper” in FIG. 5B is smaller than the gradient of temperature increase in FIG. 5A. That is, in the case where the image forming apparatus 10 performs the operation control to reduce the power for heating the fixing unit 130 by widening the interval of the “inter-paper” as illustrated in FIG. 5B, it is possible to reduce the maximum power consumption while equalizing the temperature of the fixing unit 130 at the point of time when the toner fixing to the paper is started.

Consequently, as illustrated in FIG. 4C, in the case where the image forming apparatus 10 performs operation control to reduce print speed in the printing process, it is possible to perform the print job by the printing process in which the maximum power consumption has been reduced within the above power permissible amount received from the power management server 17.

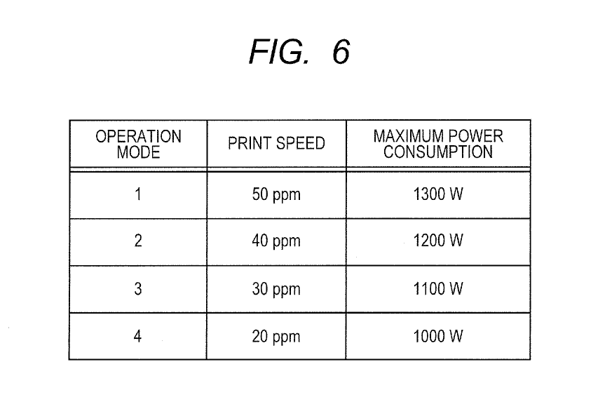

In the example illustrated in FIGS. 5A and 5B, the print speed in the operation mode in which the maximum power consumption of the image forming apparatus 10 has been restrained is limited in regard to normal print speed by 20%. For example, if the normal print speed of the image forming apparatus 10 is 50 ppm (page per minute), the print speed is limited to 40 ppm in the operation mode in which the maximum power consumption has been restrained. Incidentally, the power to be used by the image forming apparatus 10 for the printing process in the print job has been previously stored in the HDD 317 in the form of an operation mode table as illustrated in FIG. 6 on which the print speed and the maximum power consumption are associated with each other.

Thus, by referring to the operation mode table, the image forming apparatus 10 compares the power permissible amount received from the power management server 17 with the power used for the printing process in the print job to be started hereafter, or selects the operation mode which is operable in the received power permissible amount.

<Change Control of Operation Mode>

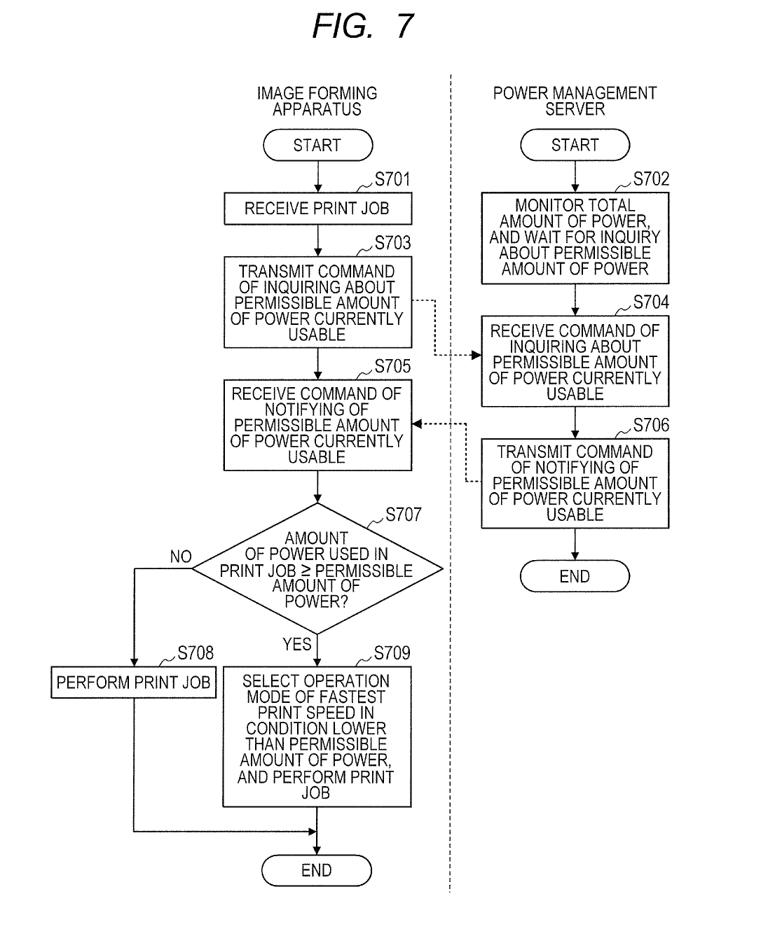

FIG. 7 is a flow chart for describing the control method of the image forming apparatus according to the present embodiment. It should be noted that the present embodiment is directed to an example of the change control of the operation mode in which the maximum power consumption is reduced when the print job of the image forming apparatus 10 is performed. Hereinafter, an example that power information indicating the power usable by the image forming apparatus is received from the power management server 17, and one of the plurality of operation modes of which the respective necessary power consumptions are different is selected for the printer 14 on the basis of the amount of power indicated by the received power information and the power permissible amount consumed in the job process to be performed will be described. Incidentally, as the operation mode to be selected, the image forming apparatus in the present embodiment has the operation mode in which an original is read, developers are transferring to a sheet based on the image data read from the original, and then the thermal fixing process is continuously performed. Moreover, the image forming apparatus in the present embodiment has the operation mode in which a pre-process of reading an original and a post-process of transferring developers to a sheet based on the image data read from the original and performing the thermal fixing process to a sheet are separated and discretely performed.

Incidentally, in the flow chart illustrated in FIG. 7, the respective steps on the side of the image forming apparatus are achieved on the condition that the CPU 301 of the main controller 11 controls the power supply control unit 318, the heater of the fixing unit 130, and the paper feeding rollers 121, 123, 125, 143 and 145 according to programs stored in the ROM 303. On the other hand, the respective steps on the side of the power management server in FIG. 7 are achieved on the condition that the CPU 17A of the power management server 17 performs applications stored in an external storage device.

Initially, in 5701, the CPU 301 of the image forming apparatus 10 starts the print job by receiving through the LAN I/F 308 the data of the print job transmitted from the PC 15 on the LAN 16. Meanwhile, in S702, the CPU 17A of the power management server 17 continuously monitors the total amount of power used in the circumstance that the image forming apparatus 10 has been installed, and waits for an inquiry concerning the permissible amount of power from the image forming apparatus 10.

In S703, the CPU 301 of the image forming apparatus 10 issues and transmits a command of inquiring about the permissible amount of power currently usable by the CPU 301 of the image forming apparatus 10, to the power management server 17 on the LAN 16 through the LAN I/F 308. In S704, the CPU 17A of the power management server 17 receives, from the image forming apparatus 10, the command of inquiring about the permissible amount of power currently usable by the image forming apparatus 10.

Next, in S706, the CPU 17A of the power management server 17 calculates the permissible amount of power currently usable by the image forming apparatus 10, on the basis of the total amount of power used in the circumstance that the image forming apparatus 10 has been installed, and issues the command for notifying the image forming apparatus 10 of the calculated permissible amount of power. Then, in S705, the image forming apparatus 10 receives, as a response to the inquiry command issued in S703, the permissible amount of power of the image forming apparatus 10 from the CPU 17A of the power management server 17.

In S707, the CPU 301 of the image forming apparatus 10 compares the amount of power used in the printing process of the print job received in S701 with the permissible amount of power received from the CPU 17A of the power management server 17 in S705. Then, if it is determined by the CPU 301 of the image forming apparatus 10 that the amount of power used in the printing process of the print job is smaller than the received permissible amount of power, in S708, the printer 14 normally performs the printing process at first print speed as illustrated in FIG. 4B, and then the print job is completed.

On the other hand, if it is determined by the CPU 301 of the image forming apparatus 10 that the amount of power used in the print job is equal to or larger than the permissible amount of power, then, in S709, the operation mode in which the amount of power to be used is smaller than the permissible amount of power and of which the print speed is highest is selected from the modes on the table illustrated in FIG. 6. Thus, the printer 14 performs the printing process to the paper at second print speed higher than the first print speed. Based on such selection, as illustrated in FIG. 4C, the CPU 301 of the image forming apparatus 10 reduces the maximum power consumption of the image forming apparatus 10 so as to be smaller than the permissible amount of power and performs the printing process, while minimizing the restrictions for decreasing the print speed. Then, the print job is completed.

In the present embodiment, the control to be performed in the case where the CPU 301 of the image forming apparatus 10 receives the data of the print job or the like from the PC 15 on the LAN 16 has been described in detail. Besides, also in a case where the print job is performed in response to an instruction accepted from the user through the operation unit 12, the operation control for reducing the maximum power consumption is performed as well as the above control.

In that case, the print job in S701 is started on the condition that the instruction of the print job is received and accepted from the user through the operation unit 12.

In the present embodiment, it is possible to select, from among the plurality of operation modes which are to be performed by the printer 14 and of which the respective power consumptions are different, the fastest operation mode within the range not exceeding the maximum power consumption permitted for the image forming apparatus, on the basis of the permissible amount of power consumed in the job process to be performed.

By the above process flow, it is possible to reduce the maximum power consumption according to the permissible amount of power usable at the time when the image forming apparatus 10 starts the print job. Incidentally, in the present embodiment, the print speed is restricted by controlling the interval of the “inter-paper”. However, even in this case, influence to the printed result does not change because the temperature of the fixing unit 130 is increased to the temperature equal to or higher than the melting point of the toner to be fixed to the paper.

### Second Embodiment

### Image Forming Apparatus

Hereinafter, the second embodiment of the present invention will be described with reference to the attached drawings. In the second embodiment, an example of operation control to be performed in a case where a copy job is performed based on an instruction accepted from a user through the operation unit 12 will be described. More specifically, the operation control aims to reduce the maximum power consumption according to the permissible amount of power usable by the image forming apparatus 10.

In the present embodiment, it is possible to reduce the maximum power consumption, by the operation control of chronologically separating the scanning process of the scanner 13 and the printing process of the printer 14 from each other in the copy job. In any case, since the constitution of the image forming apparatus in the second embodiment is the same as that of the image forming apparatus 10 in the first embodiment, only different portions in the operation control to be performed in the copy job will be described hereinafter.

<Image Forming Apparatus/Operation Control in Normal Power Mode>

In the present embodiment, as well as the first embodiment, the image forming apparatus 10 has the two power modes which are roughly classified into the normal power mode and the power saving mode of which the respective power states are different according to operation conditions of the apparatus. However, unlike the print job in the first embodiment, in the copy job of the image forming apparatus 10 in the present embodiment, the scanning process of the scanner 13 for reading an original is performed in parallel with the printing process of the printer 14 for fixing a toner to a paper.

For this reason, as compared with the maximum power consumption at the time when the image forming apparatus 10 performs the print job in the first embodiment, the power consumption of the image forming apparatus 10 in the present embodiment increases by the power consumption necessary for the scanning process of the scanner 13. Consequently, in the normal power mode of the image forming apparatus 10 in the present embodiment, the operation control for reducing the maximum power consumption is performed in accordance with the power usable at the time when the image forming apparatus 10 starts the copy job.

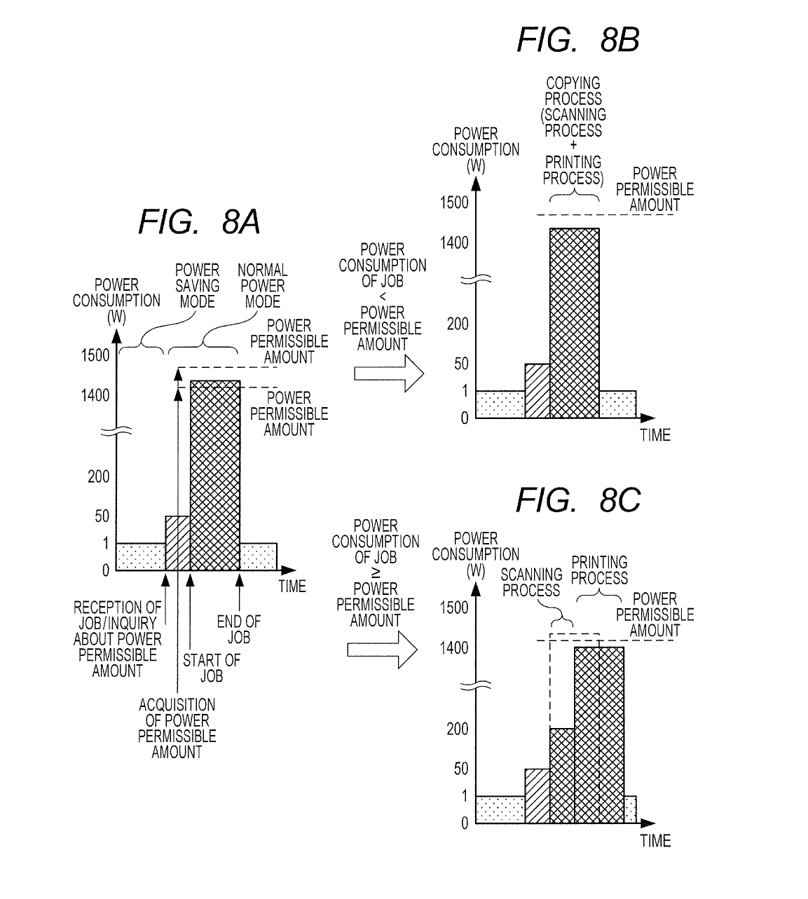

FIGS. 8A to 8C are characteristic diagrams for describing the states of the power consumption according to the job process of the image forming apparatus according to the present embodiment. Hereinafter, transition of the operation mode from the power saving mode to the normal power mode and the copy job that the image forming apparatus 10 performs in the normal power mode will be described with reference to FIGS. 8A to 8C. Here, it should be noted that, in each of FIGS. 8A to 8C, the vertical axis indicates the power consumption (W) of the image forming apparatus 10 and the horizontal axis indicates time.

Initially, the original is put on the automatic document feeder 142 or the platen glass 101 by the user. Then, when an instruction of the copy job is accepted from the user through the operation unit 12, the copy job is performed.

As illustrated in FIG. 8A, when the image forming apparatus 10 in the power saving mode receives the instruction of the copy job from the user, the operation mode is transitioned to the normal power mode. Then, the image forming apparatus 10 inquires of the power management server 17 as to a power permissible amount of the power which is currently usable by the image forming apparatus 10. Subsequently, the power management server 17, which has the same constitution as that described in the first embodiment, notifies, as the power permissible amount, the power usable by the image forming apparatus 10 in regard to the inquiry from the image forming apparatus 10.

When the information indicating the power permissible amount is received from the power management server 17, the image forming apparatus 10 compares the received power permissible amount with the power to be used in the scanning process and the printing process of the copy job started hereafter. Then, if the received power permissible amount is larger than the power consumption necessary for the scanning process and the printing process of the copy job started hereafter by the image forming apparatus 10, the normal copy job can be performed within the range of the power usable by the image forming apparatus 10.

Thus, the image forming apparatus 10 normally performs the copy job as illustrated in FIG. 8B. On the other hand, if the received power permissible amount is equal to or smaller than the power consumption necessary for the scanning process and the printing process of the copy job started hereafter by the image forming apparatus 10, the normal copy job cannot be performed within the range of the power usable by the image forming apparatus 10.

Consequently, the operation control which will be described in detail hereinafter is performed to reduce the maximum power consumption of the image forming apparatus 10. The maximum power consumption at the time when the image forming apparatus 10 performs the copy job includes, in addition to the maximum power consumption necessary for the printing process of the printer 14 at the time when the print job is performed in the first embodiment, the power consumption necessary for the scanning process of the scanner 13 to be performed in parallel with the printing process.

Therefore, as illustrated in FIG. 8C, the image forming apparatus 10 performs the operation control of chronologically separating the scanning process of the scanner 13 and the printing process of the printer 14 from each other in the copy job, without simultaneously performing these processes. Initially, in the scanning process of the scanner 13, the digital data acquired by reading the original is temporarily stored in the HDD 317. Then, after the scanning process was completed, the printing process of the printer 14 is performed to print the previously stored digital data of the original.

Thus, as illustrated in FIG. 8C, although the total time necessary for the copy job is prolonged, it is possible to reduce the maximum power consumption of the image forming apparatus 10. Consequently, it is possible to perform the copy job within the range of the power permissible amount received from the power management server 17.

<Change Control of Operation Mode>

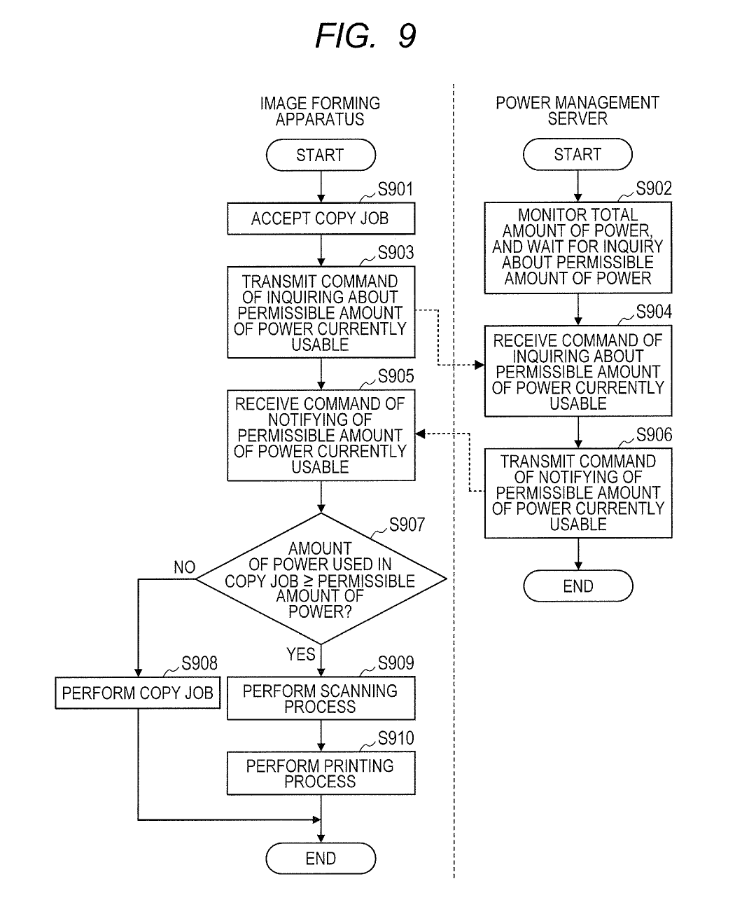

FIG. 9 is a flow chart for describing the control method of the image forming apparatus according to the present embodiment. It should be noted that the present embodiment is directed to an example of the change control of the operation mode in which the maximum power consumption is reduced when the print job of the image forming apparatus 10 is performed. Hereinafter, an example of the operation control of properly changing the copy function process using the printer 14 and the scanner 13, the original reading operation by the scanner 13 and the printing operation by the printer 14 according to the information received from the power management server will be described.

Incidentally, in the flow chart illustrated in FIG. 9, the respective steps on the side of the image forming apparatus are achieved on the condition that the CPU 301 of the main controller 11 controls the power supply control unit 318, the scanner 13 and the printer 14 according to programs stored in the ROM 303. On the other hand, the respective steps on the side of the power management server in FIG. 9 are achieved on the condition that the CPU 17A of the power management server 17 performs applications stored in an external storage device.

Initially, in S901, the copy job is started by receiving and accepting the instruction of the copy job from the user through the operation unit 12. Here, it should be noted that the steps in S902 to S906 are the same as those in S702 to S706 respectively.

In S907, the CPU 301 of the image forming apparatus 10 compares the amount of power used in the scanning process and the printing process of the copy job received in S901 with the permissible amount of power received from the CPU 17A of the power management server 17 in S905. Then, if it is determined by the CPU 301 of the image forming apparatus 10 that the amount of power used in the scanning process and the printing process of the copy job is smaller than the received permissible amount of power, in S908, the printer normally performs the copy job as illustrated in FIG. 8B, and the copy job is completed.

On the other hand, if it is determined by the CPU 301 of the image forming apparatus 10 that the amount of power used in the copy job is equal to or larger than the permissible amount of power, then, in S909, the scanner 13 sequentially reads the originals put on the apparatus by the user, and stores the digital data of the originals in the HDD 317. Next, in S910, the printer 14 performs the printing process to print the digital data of the original read in S909 as illustrated in FIG. 8C. Then, the copy job is completed.

According to the above process flow, it is possible to reduce the maximum power consumption of the image forming apparatus 10, by performing the operation control of chronologically separating the processes of the scanner 13 and the printer 14 from each other without simultaneously performing these processes at the time when the image forming apparatus 10 performs the copy job. Besides, although the total time necessary for the copy job is prolonged, the influence to the printed result does not change.

### Third Embodiment

### Image Forming Apparatus

Hereinafter, the third embodiment of the present invention will be described with reference to the attached drawings. In the third embodiment, an example of operation control which aims to reduce the maximum power consumption by combining the operation control of reducing the print speed described in the first embodiment with the operation control of chronologically separating the scanning process and the printing process from each other in the copy job described in the second embodiment will be described. In any case, since the constitution of the image forming apparatus in the third embodiment is the same as that of the image forming apparatus 10 in the first and second embodiments, only different portions in the operation control to be performed in the copy job will be described hereinafter.

<Image Forming Apparatus/Operation Control in Normal Power Mode>

In the present embodiment, as well as the first and second embodiments, the image forming apparatus 10 has the two power modes which are roughly classified into the normal power mode and the power saving mode of which the respective power states are different according to operation conditions of the apparatus.

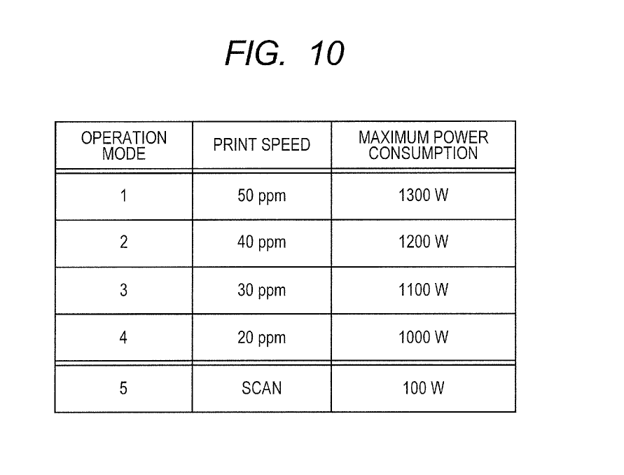

Moreover, in the normal power mode of the present embodiment, as exemplarily illustrated in FIG. 10, the item concerning the power consumption necessary for the scanning process is added to the operation mode table illustrated in FIG. 6. Thus, the image forming apparatus 10 in the present embodiment performs the operation control for performing the copy job in the operation mode of the maximum power consumption based on the operation mode table illustrated in FIG. 10.

<Change Control of Operation Mode>

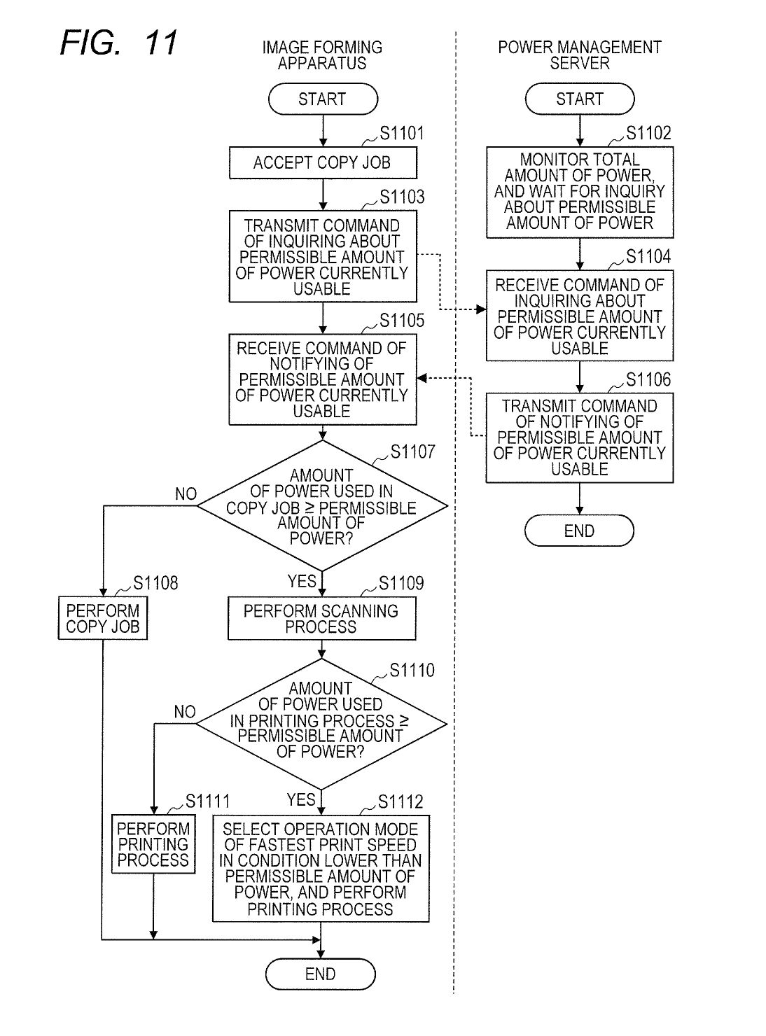

FIG. 11 is a flow chart for describing the control method of the image forming apparatus according to the present embodiment. It should be noted that the present embodiment is directed to an example of the change control of the operation mode in which the maximum power consumption is reduced when the print job of the image forming apparatus 10 is performed. Incidentally, in the illustrated flow chart, the respective steps on the side of the image forming apparatus are achieved on the condition that the CPU 301 of the main controller 11 controls the power supply control unit 318, the heater of the fixing unit 130, the paper feeding rollers 121, 123, 125, 143 and 145, the scanner 13 and the printer 14 according to programs stored in the ROM 303. On the other hand, the respective steps on the side of the power management server in FIG. 11 are achieved on the condition that the CPU 17A of the power management server 17 performs applications stored in an external storage device.

Incidentally, it should be noted that the steps in S1101 to S1106 are the same as those in S901 to S906 respectively. Subsequently, in S1107, the CPU 301 of the image forming apparatus 10 compares the amount of power used in the copy job received in S1101 with the permissible amount of power received from the CPU 17A of the power management server 17 in S1105. Then, if it is determined by the CPU 301 of the image forming apparatus 10 that the amount of power used in the copy job is smaller than the received permissible amount of power, in S1108, the printer normally performs the copy job, and the copy job is completed.

On the other hand, if it is determined by the CPU 301 of the image forming apparatus 10 that the amount of power used in the copy job is equal to or larger than the received permissible amount of power, then, in S1109, the scanner 13 sequentially reads the originals put on the apparatus by the user, and stores the digital data of the originals in the HDD 317.

Next, in S1110, the amount of power consumption necessary for the printing process in which the power consumption necessary for the scanning process has been subtracted from the power consumption necessary for the copy job is compared with the permissible amount of power received from the CPU 17A of the power management server 17 in S1105, on the basis of the operation mode table illustrated in FIG. 10. If it is determined by the CPU 301 of the image forming apparatus 10 that the power necessary for the printing process is smaller than the permissible amount of power, then in S1111, the printer 14 performs the printing process to print the digital data of the original read in S1110, and then the copy job is completed.

On the other hand, if it is determined by the CPU 301 of the image forming apparatus 10 that the power used for the print job is equal to or larger than the permissible amount of power, then in S1112, the operation mode of which the power consumption is smaller than the permissible amount of power and of which the print speed is fastest is selected from the operation mode table illustrated in FIG. 10. On the condition that the relevant operation mode has been selected, the image forming apparatus 10 reduces the maximum power consumption of the image forming apparatus 10 to be smaller than the permissible amount of power and performs the printing process, while minimizing the restrictions for decreasing the print speed. Then, the print job is completed. Incidentally, in the present embodiment, after the pre-process (S1109) was performed, the CPU 301 further selects the one operation mode from among the plurality of operation modes which are to be performed by the printer 14 and of which the respective power consumptions are different, from the amount of power specified by the received power information and the permissible amount of power consumed in the job process to be performed.

According to the above process flow, it is possible to reduce the maximum power consumption by performing the operation control of chronologically separating the scanning process and the printing process from each other in the copy job and further reducing the print speed in the printing process. As described above, with respect to the power consumption of the scanning process and the printing process in the copy job, the power consumption for the printing process for which it is necessary to heat the fixing unit 130 by the heater is larger than that for the scanning process.

Consequently, in the case where the power consumption for the printing process is equal to or larger than the permissible amount of power of the image forming apparatus 10, it is conceivable in the second embodiment that the printing process cannot be performed after the scanning process was completed. Therefore, in the present embodiment, the operation control for reducing the print speed is performed as well as the first embodiment even in the printing process of the copy job, thereby enabling the printing process by reducing the maximum power consumption to be within the rage of the permissible amount of power.

Moreover, if it is possible to satisfy the power permissible amount only by performing the operation control of chronologically separating the scanning process and the printing process from each other in the copy job, it is unnecessary to reduce the print speed in the printing process. Conversely, even if it is necessary to reduce the print speed of the printing process in the copy job, it is possible to shorten the width of reduction of the print speed in the printing process. This is also an advantage of the present embodiment.

This corresponds to, for example, a case where, although it is necessary to reduce the print speed up to 30 ppm if the scanning process and the printing process are not chronologically separated from each other, it is possible to satisfy the power permissible amount only by reducing the print speed up to 40 ppm if the scanning process and the printing process are chronologically separated from each other.

Modification

In the above second embodiment, in the copy job, the scanning process and the printing process are chronologically separated from each other. However, in the present invention, the operation of chronologically dividing the one job into the plurality of processes is not limited to the above operation.

That is, in the present invention, in case of reducing the maximum power consumption according to the permissible amount of power in the image forming apparatus capable of processing the plurality of jobs in parallel, it is possible to chronologically shift the plurality of jobs and perform the shifted jobs. For example, in the image forming apparatus capable of performing in parallel the print job using the printer 14 and a send job using the LAN I/F 308, in case of reducing the maximum power consumption according to the permissible amount of power, it is possible to perform the print job and the send job after chronologically dividing them.

Moreover, for example, in a facsimile job of performing the above printing process on a sheet based on image information to be received, this job is first divided into a memory reception job and the print job of printing on the sheet the image information stored in a memory in the memory reception job. Then, it is possible to control the image forming apparatus to perform the memory reception job as the pre-process and perform the print job as the post-process in accordance with the procedures described in the second and third embodiments. This is also within the scope to which the present invention is applicable.

It is also possible to achieve each of the steps in the present invention, under the condition that a processing device (a CPU, a processor) of a personal computer or the like executes software (programs) acquired through a network or various storage media.

It should be noted that the present invention is not limited to the above embodiments. That is, various modifications (including organic combinations of the respective embodiments) can be achieved based on the purpose of the present invention, and these modifications are not excluded from the scope of the present invention.

In any case, according to the present invention, even if a job for which there is a strong possibility that the necessary power exceeds the maximum power consumption is requested, it is possible to process the job in the operation mode in which the necessary power does not exceed the maximum poser consumption.

### Other Embodiments

Embodiments of the present invention can also be realized by a computer of a system or an apparatus that reads out and executes computer executable instructions recorded on a storage medium (e.g., a non-transitory computer-readable storage medium) to perform the functions of one or more of the above embodiments of the present invention, and by a method performed by the computer of the system or the apparatus by, for example, reading out and executing the computer executable instructions from the storage medium to perform the functions of one or more of the above embodiments. The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to the exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-267893, filed Dec. 7, 2012, which is hereby incorporated by reference herein in its entirety.

What is claimed is:

1. An image forming apparatus comprising:
a reading unit configured to read an image of an original in a reading operation;
a printing unit configured to print an image on a paper in a printing operation;
a receiving unit configured to receive information for restricting an amount of power that the image forming apparatus can use; and
a control unit configured to, in case of performing a copy function by which the printing unit prints an image on a paper based on image data acquired by the reading unit, perform control not to simultaneously perform the reading operation in which the reading unit reads the image of the original and the printing operation in which the printing unit prints the image on the paper, when the receiving unit has received the information, and perform control to simultaneously perform the reading operation in which the reading unit reads the image of the original and the printing operation in which the printing unit prints the image on the paper, when the receiving unit does not receive the information.

2. The image forming apparatus according to claim 1, wherein the receiving unit receives the information from an external device through a network.

3. The image forming apparatus according to claim 1, wherein the information includes information indicating the amount of power that the image forming apparatus can use.

4. The image forming apparatus according to claim 1, further comprising a comparison unit configured to compare the amount of power indicated by the information received by the receiving unit with an amount of power necessary to perform the copy function,
wherein, in a case where, as a result of the comparison by the comparison unit, the amount of power necessary to perform the copy function exceeds the amount of power indicated by the information received by the receiving unit, the control unit performs the control not to simultaneously perform the reading operation in which the reading unit reads the image of the original and the printing operation in which the printing unit prints the image on the paper, and, in a case where, as the result of the comparison by the comparison unit, the amount of power necessary to perform the copy function does not exceed the amount of power indicated by the information received by the receiving unit, the control unit performs the control to simultaneously perform the reading operation in which the reading unit reads the image of the original and the printing operation in which the printing unit prints the image on the paper.

5. The image forming apparatus according to claim 1, wherein, when the receiving unit does not receive the information, the control unit performs the control to perform the printing operation in which the printing unit prints the image on the paper after performing the reading operation in which the reading unit reads the image of the original.

6. An image forming apparatus comprising:
a printing unit configured to print an image on a paper;
a receiving unit configured to receive information for restricting an amount of power that the image forming apparatus can use; and
a control unit configured to control the printing unit to print the image on the paper at first print speed in a case where the receiving unit receives the information, and control the printing unit to print the image on the paper at second print speed higher than the first print speed in a case where the receiving unit does not receive the information.

7. The image forming apparatus according to claim 6, wherein the receiving unit receives the information from an external device through a network.

8. The image forming apparatus according to claim 6, wherein the information includes information indicating the amount of power that the image forming apparatus can use.

9. The image forming apparatus according to claim 6, further comprising a comparison unit configured to compare the amount of power indicated by the information received by the receiving unit with an amount of power necessary for the printing unit to print the image at the second print speed,
wherein, in a case where, as a result of the comparison by the comparison unit, the amount of power necessary for the printing unit to print the image at the second print speed exceeds the amount of power indicated by the information received by the receiving unit, the control unit controls the printing unit to print the image on the paper at the first print speed, and, in a case where, as the result of the comparison by the comparison unit, the amount of power necessary for the printing unit to print the image at the second print speed does not exceed the amount of power indicated by the information received by the receiving unit, the control unit controls the printing unit to print the image on the paper at the second print speed.

10. A control method for an image forming apparatus which comprises a reading unit configured to read an image of an original in a reading operation and a printing unit configured to print an image on a paper in a printing operation, the method comprising:
a receiving step of receiving information for restricting an amount of power that the image forming apparatus can use; and
a control step of, in case of performing a copy function by which the printing unit prints an image on a paper based on image data acquired by the reading unit, performing control not to simultaneously perform the reading operation in which the reading unit reads the image of the original and the printing operation in which the printing unit prints the image on the paper, when the information was received in receiving step, and performing control to simultaneously perform the reading operation in which the reading unit reads the image of the original and the printing operation in which the printing unit prints the image on the paper, when the information is not received in the receiving step.

11. A control method for an image forming apparatus which comprises a printing unit to print an image on a paper, the method comprising:
a receiving step of receiving information for restricting an amount of power that the image forming apparatus can use; and
a control step of controlling the printing unit to print the image on the paper at first print speed in a case where the information was received in the receiving step, and controlling the printing unit to print the image on the paper at second print speed higher than the first print speed in a case where the information is not received in the receiving step.

12. A program for causing a computer to perform the control method for the image forming apparatus described in claim 10.

13. A program for causing a computer to perform the control method for the image forming apparatus described in claim 11.
